(19) United States
(12) Patent Application Publication
(10) Pub. No.: US 2026/0094377 A1
(43) Pub. Date: Apr. 2, 2026

(54) SYSTEMS AND METHODS FOR LOD GENERATION FOR BLENDSHAPES

(71) Applicant: Electronic Arts Inc., Redwood City, CA (US)

(72) Inventors: Ashton MASON, Brighton (GB); Joseph HARMON, Altamonte Springs, FL (US)

(73) Assignee: Electronic Arts Inc., Redwood City, CA (US)

(21) Appl. No.: 18/900,260

(22) Filed: Sep. 27, 2024

(51) Int. Cl. G06T 17/20; G06T 19/20

(52) U.S. Cl. CPC G06T 17/205; G06T 19/20; G06T 2210/36; G06T 2219/2004; G06T 2219/2016

(57) ABSTRACT

A method, device, and computer-readable storage medium for generating levels-of-detail (LODs) for blendshape assets is disclosed. Given a base target and a set of blendshape targets, a LOD for the base target is generated based on performing edge collapse operations on the base target, where the edge collapse operations that are performed are informed by not only the geometry of the base target, but also the geometries of the blendshape targets. In some cases, the same edge collapse operations can also be performed on the blendshape targets to generate LODs for the blendshape targets, thereby maintaining topological consistency between the LODs for the base target and the blendshape targets. In some cases, a morphing operator can take as input a LOD of the base target and generate a LOD for a blendshape target.

### TECHNICAL FIELD

This disclosure generally relates to computer graphics and, more particularly, to systems and methods for generating Levels of Detail (LODs) for blendshapes.

### BACKGROUND

For three-dimensional (3D) graphics applications, such as video games or animated films, efficient processing of data by reducing computational complexity of a given operation is often useful. This is particularly the case in real-time applications, such as video games.

Various operations can be performed using computer-generated objects in a scene. An object may be represented as a polygonal mesh, which comprises a collection of vertices, edges, and faces that define the shape and/or boundary of the object.

One technique to reduce the computational complexity of a given graphics operation involving a 3D object is to use a lower complexity stand-in for the 3D object. For 3D objects that comprise a polygonal mesh, mesh simplification can be performed on the 3D object to produce simplified versions of the polygonal mesh called Levels of Detail (LODs). For example, a LOD can be used as a stand-in for the original (full-resolution model) in-game when the modelled 3D object is far from the camera and thus small on screen.

Polygonal meshes can be simplified by edge collapse to generate LODs, where an edge in a mesh is replaced with a single vertex in the simplified mesh. Some mesh simplification methods collapse single edges at each pass. Other mesh simplification methods collapse multiple edges at once in what is called polychord collapse, allowing the simplified mesh to preserve the grid-like topology of semi-regular quad mesh models that are often used in games.

In some implementations, a given polygonal mesh can be associated with a set of blendshapes. Using blendshapes, a collection of meshes is generated with identical topology (e.g., same number of faces and edges), but different geometry or shape. The different geometries are called blendshape targets, and are effectively different poses of the same base target mesh. Blendshapes are often used to model characters or clothing, where the different blendshape target meshes represent different body types. Blendshapes allow for the base mesh to take on a variety of appearances without needing to create many separate models. The blendshape framework can also be used to create animations by interpolating between blendshapes.

LODs can also be used together with blendshapes. Because corresponding LODs of different blendshape targets must have identical topology, standard LOD generation tools that naively generate LODs for each target independently typically cannot be used. This is because traditional simplification operations performed on a mesh depend on the geometry of the mesh, and thus LODs generated independently for different blendshape targets are likely to have different topology, which violates the blendshape framework.

Accordingly, there remains a need in the art for an improved system and method for generating Levels of Detail (LODs) for blendshapes.

### SUMMARY

Embodiments of the disclosure provide a method, device, and computer-readable storage medium for generating a simplified mesh. The method includes: receiving a base target mesh, wherein the base target mesh is a polygonal mesh having a first topology, wherein the base target mesh is associated with a set of blendshape targets to deform the base target mesh, wherein each blendshape target in the set of blendshape targets has the first topology; determining a set of edge collapse operations of the base target mesh that reduce a number of triangles of the base target mesh; for each edge collapse operation in the set of edge collapse operations, determining a set of values corresponding to performing the edge collapse operation on the base target mesh and each blendshape target in the set of blendshape targets, wherein each value in the set of values is based on a cost metric and a benefit metric of performing the edge collapse operation on the base target mesh or a respective blendshape target in the set of blendshape targets; for each set of values corresponding to respective edge collapse operations, aggregating the values in the set of values to determine an aggregate value for performing the edge collapse operation on the base target mesh and each blendshape target in the set of blendshape targets; selecting a first edge collapse operation from the set of edge collapse operations having an optimal (for example, largest) aggregate value; and performing the first edge collapse operation on the base target mesh to generate a simplified base target mesh.

Other embodiments of the disclosure provide a method, device, and computer-readable storage medium for generating a simplified blendshape target corresponding to a first blendshape target in a set of blendshape targets based on morphing a simplified base target mesh. Generating the simplified blendshape target comprises: creating a copy mesh of the simplified base target mesh; and for each vertex in the simplified base target mesh: determining a texture space coordinate of the vertex in the simplified base target mesh; identifying a point on the base target mesh corresponding to the texture space coordinate; identifying a first set of three vertices of the base target mesh that form a triangle that contains the point on the base target mesh; identifying a second set of three vertices of the first blendshape target that corresponds to the first set of three vertices of the base target mesh; for each vertex in the first set of three vertices, calculating a translation metric corresponding to a difference in location of the vertex in the first set of three vertices and the corresponding vertex in the second set of three vertices; for each vertex in the first set of three vertices, calculating a rotation metric corresponding to a difference in a surface normal of the vertex in the first set of three vertices and the corresponding vertex in the second set of three vertices; aggregating the translation metrics to generate an aggregated translation metric; aggregating the rotation metrics to generate an aggregated rotation metric; identifying, for the vertex in the simplified base target mesh, a corresponding vertex in the copy mesh of the simplified base target mesh; and transforming a position and a rotation of the corresponding vertex in the copy mesh based on the aggregated translation metric and the aggregated rotation metric.

### BRIEF DESCRIPTION OF THE DRAWINGS

FIG. 1 is a block diagram of a computer system for rendering images, according to aspects of the present disclosure.

FIG. 2 is a block diagram illustrating processor and buffer interaction, according to one embodiment.

FIG. 3 is an example of a polygonal mesh, according to one embodiment.

FIG. 4 is an exploded view of the object defined by the polygonal mesh shown in FIG. 3, according to one embodiment.

FIG. 5 is an example of a level-of-detail mesh corresponding to the polygonal mesh in FIG. 3, according to one embodiment.

FIG. 6 is a block diagram illustrating a base target, blendshape targets, and corresponding blendshapes, according to one embodiment.

FIG. 7 illustrates a matrix of a base target, blendshape targets, and their corresponding LODs, according to one embodiment.

FIG. 8 is a conceptual diagram illustrating a face of a polygonal mesh, in one embodiment.

FIG. 9 illustrates a portion of mesh with different UV values for a vertex of the mesh, in one embodiment.

FIG. 10 illustrates a base target, a blendshape target, and LODs of the base target and the blendshape target, according to one embodiment.

FIG. 11 is a conceptual diagram illustrating edge collapse, according to one embodiment.

FIG. 12 is a conceptual diagram illustrating polychord collapse, according to one embodiment.

FIG. 13 illustrates a self-intersecting polychord, in one embodiment.

FIG. 14 illustrates using the Morph operator to generate a LOD for a blendshape target, in one embodiment.

FIG. 15 illustrates the UV islands of the different LODs that are topologically different, in one embodiment.

FIG. 16 illustrates a point on a base target and corresponding point on a destination target, in one embodiment.

FIG. 17 is an example of a mesh representing trousers, in one embodiment.

FIG. 18 is an example of the UV layout for the trousers, in one embodiment.

FIG. 19 is a flow diagram of method steps for simplifying a mesh, according to one embodiment.

FIG. 20 is a flow diagram of method steps for generating a simplified blendshape target corresponding to a first blendshape target in a set of blendshape targets based on morphing a simplified base target mesh, according to one embodiment.

### DETAILED DESCRIPTION

The following detailed description provides examples and is not intended to limit the disclosure or the application and uses of the disclosure. Furthermore, there is no intention to be bound by any expressed or implied theory presented in the preceding technical field, background, summary, brief description of the drawings, or the following detailed description.

Embodiments of the disclosure provide a system and method for generating Levels of Detail (LODs) for a series of blendshape assets.

As described, a three-dimensional (3D) asset, such as a character or a head of a character in a game, includes a main graphics mesh hand-authored by an artist, plus a number of secondary meshes that are used for a variety of other purposes. These secondary meshes are often specialized or simplified versions of the primary graphics mesh. A classic example of secondary meshes are level-of-detail (LOD) meshes, which are simplified versions of the primary graphics mesh, with successively fewer triangles, used as stand-ins for the primary mesh when the model is far away.

In some implementations, to generate the LODs, a series of simplified versions of an input polygonal mesh is generated. The simplified versions can be generated using a variety of mesh simplification techniques in which individual edges of the mesh are collapsed iteratively to successively reduce the triangle count of the polygonal mesh. When an edge is collapsed, the edge is replaced with a single vertex, and any incident faces are updated accordingly. The vertex is placed so as to optimally approximate the original geometry in the patch of surrounding faces.

As used herein, a blendshape is a collection of meshes with identical topology (e.g., same number of vertices, faces, and edges), but different geometry or shape. The different geometries are called blendshape targets, and are effectively different poses of the same base mesh. Blendshapes are often used to model characters, or clothing, where the different blendshape target meshes represent different body types. Typically, a blendshape has a base mesh (also called “base target”) and a series of other targets in more specialized poses.

By blending between the different blendshape target meshes at render time, a single model takes on a variety of different shapes, linearly combining the shapes of the blendshape targets. Such a system can, for example, allow players of a game to create a wide variety of custom characters, by intuitively combining different body styles. A key advantage of blendshapes is that the wide variety of character shapes that can be authored are represented in-game by a single blendshape model.

The blendshapes rendering system supports LODs (i.e., simplified versions of the target meshes, at successively lower triangle budgets). Authoring LODs for blendshapes allows rendering budget to be saved by rendering less detailed versions when the modelled character is far away, and thus small on the screen. Instead of blending between the full-resolution meshes of all the blendshape targets, the engine can switch to blending between less detailed versions of the meshes, with fewer triangles, when the model is further away than a threshold distance. In order for this to work, LODs meshes must be authored consistently for all targets, meaning that corresponding LOD meshes of the different blendshape targets must have exactly identical topology across all blendshape targets.

In one embodiment, an artist can author full-resolution (LOD_0) meshes of all the blendshape targets. In other embodiments, the artist authors the full-resolution LOD_0 mesh of base target, and the other blendshape targets can be generated using any other technique. These LOD_0 meshes of the base target and the other blendshape targets have identical topology, but different geometries, representing different poses.

After the base target and the other blendshape targets have been authored or otherwise generated, some embodiments of the disclosure use a “Generate” operator to create the other LODs of the base target and/or the other blendshape targets. In some embodiments, the Generate operator is able to output a full set of LODs for each blendshape target. It ensures that the generated LODs share a single topology across all blendshape targets (but different geometries) matching the blendshape targets. According to embodiments of the disclosure, when generating a simplified topology for the base target and/or the blendshape targets, the Generate operator takes into account all the blendshape target geometries, keeping edges where needed to support the geometries of the various blendshape target shapes, even if they are not needed in the base target. Usefully, much of the processing is common to all blendshape targets, reducing processing time.

In one embodiment, the Generate operator that takes into account all blendshape target geometries can be used to generate a set of LODs for the base target. In another embodiment, after the LOD_0 meshes of the base target and the other blendshape targets have been authored or otherwise generated, the artist may also author the lower-detail LODs of just the base target. In one embodiment, the artist may generate an initial set of LODs for the base target automatically (for example, using the Generate command) as a starting point, and then improve them with some hand-authoring. Note that even when LODs are output for just the base target using the Generate operator, the generated LODs are still informed by the geometries of the other targets—keeping edges where they are required to support all geometries.

Once a set of LODs for the base target is known, some embodiments use a “Morph” operator to generate the corresponding low-detail LODs for the other blendshape targets. This morphing of the other LODs uses the artist-authored full-res LOD_0 meshes of the blendshape targets as geometry references. The meshes morphed for the other blendshape targets retain the topology of the LODs authored for the base target, but take on geometry (i.e., vertex positions and normals) matching their respective full-resolution LOD_0 blendshape target meshes.

Taking the context of video games as an example, the display of a video game is generally a video sequence presented to a display device capable of displaying the video sequence. The video sequence typically comprises a plurality of frames. By showing frames in succession in sequence order, simulated objects appear to move. A game engine typically generates frames in real-time response to user input, so rendering time is often constrained.

As used herein, a “frame” refers to an image of the video sequence. In some systems, such as interleaved displays, the frame might comprise multiple fields or more complex constructs, but generally a frame can be thought of as a view into a computer-generated scene at a particular time or short time window. For example, with 60 frames-per-second video, if one frame represents the scene at t=0 seconds, then the next frame would represent the scene at t= 1/60 seconds. In some cases, a frame might represent the scene from t=0 seconds to t= 1/60 seconds, but in the simple case, the frame is a snapshot in time.

A “scene” comprises those simulated objects that are positioned in a world coordinate space within a view pyramid, view rectangular prism, or other shaped view space. In some approaches, the scene comprises all objects (that are not obscured by other objects) within a view pyramid defined by a view point and a view rectangle with boundaries being the perspective planes through the view point and each edge of the view rectangle, possibly truncated by a background.

The simulated objects can be generated entirely from mathematical models describing the shape of the objects (such as arms and a torso described by a set of plane and/or curve surfaces), generated from stored images (such as the face of a famous person), or a combination thereof. If a game engine (or more specifically, a rendering engine that is part of the game engine or used by the game engine) has data as to where each object or portion of an object is in a scene, the frame for that scene can be rendered using standard rendering techniques.

A scene may comprise several objects or entities with some of the objects or entities being animated, in that the objects or entities may appear to move either in response to game engine rules or user input. For example, in a basketball game, a character for one of the basketball players might shoot a basket in response to user input, while a defending player will attempt to block the shooter in response to logic that is part of the game rules (e.g., an artificial intelligence component of the game rules might include a rule that defenders block shots when a shot attempt is detected) and when the ball moves through the net, the net will move in response to the ball. The net is expected to be inanimate, but the players'movements are expected to be animated and natural-appearing. Animated objects are typically referred to herein generically as characters and, in specific examples, such as animation of a football, soccer, baseball, basketball, or other sports game, the characters are typically simulated players in the game. In many cases, the characters correspond to actual sports figures and those actual sports figures might have contributed motion capture data for use in animating their corresponding character. Players and characters might be nonhuman, simulated robots, or other character types.

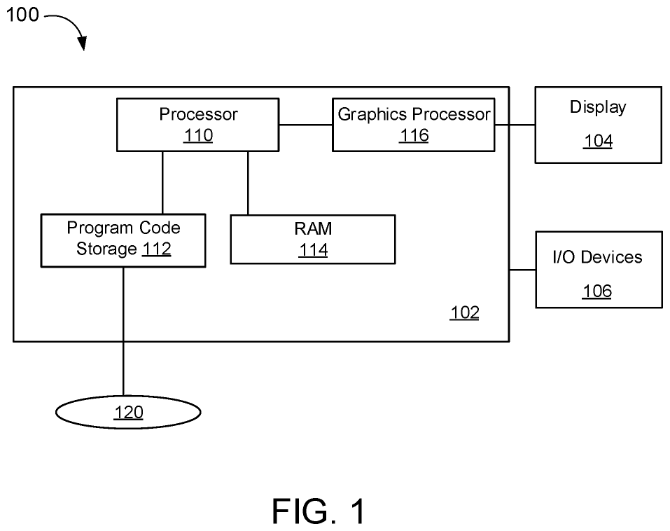

Turning to the drawings, FIG. 1 is a block diagram of a computer system 100 for rendering images, according to aspects of the present disclosure. The computer system 100 may be, for example, used for rendering images of a video game. The computer system 100 is shown comprising a console 102 coupled to a display 104 and input/output (I/O) devices 106. Console 102 is shown comprising a processor 110, program code storage 112, temporary data storage 114, and a graphics processor 116. Console 102 may be a handheld video game device, a video game console (e.g., special purpose computing device) for operating video games, a general-purpose laptop or desktop computer, or other suitable computing system, such as a mobile phone or tablet computer. Although shown as one processor in FIG. 1, processor 110 may include one or more processors having one or more processing cores. Similarly, although shown as one processor in FIG. 1, graphics processor 116 may include one or more processors having one or more processing cores.

Program code storage 112 may be ROM (read only-memory), RAM (random access memory), DRAM (dynamic random access memory), SRAM (static random access memory), hard disk, other magnetic storage, optical storage, other storage or a combination or variation of these storage device types. In some embodiments, a portion of the program code is stored in ROM that is programmable (e.g., ROM, PROM (programmable read-only memory), EPROM (erasable programmable read-only memory), EEPROM (electrically erasable programmable read-only memory), etc.) and a portion of the program code is stored on removable media such as a disc 120 (e.g., CD-ROM, DVD-ROM, etc.), or may be stored on a cartridge, memory chip, or the like, or obtained over a network or other electronic channel as needed. In some implementations, program code can be found embodied in a non-transitory computer-readable storage medium.

Temporary data storage 114 is usable to store variables and other game and processor data. In some embodiments, temporary data storage 114 is RAM and stores data that is generated during play of a video game, and portions thereof may also be reserved for frame buffers, depth buffers, polygon lists, texture storage, and/or other data needed or usable for rendering images as part of a video game presentation.

In one embodiment, I/O devices 106 are devices a user interacts with to play a video game or otherwise interact with console 102. I/O devices 106 may include any device for interacting with console 102, including but not limited to a video game controller, joystick, keyboard, mouse, keypad, VR (virtual reality) headset or device, etc.

Display 104 can any type of display device, including a television, computer monitor, laptop screen, mobile device screen, tablet screen, etc. In some embodiments, I/O devices 106 and display 104 comprise a common device, e.g., a touchscreen device. Still further, in some embodiments, one or more of the I/O devices 106 and display 104 is integrated in the console 102.

In various embodiments, since a video game is likely to be such that the particular image sequence presented on the display 104 depends on results of game instruction processing, and those game instructions likely depend, in turn, on user inputs, the console 102 (and the processor 110 and graphics processor 116) are configured to quickly process inputs and render a responsive image sequence in real-time or near real-time.

Various other components may be included in console 102, but are omitted for clarity. An example includes a networking device configured to connect the console 102 to a network, such as the Internet.

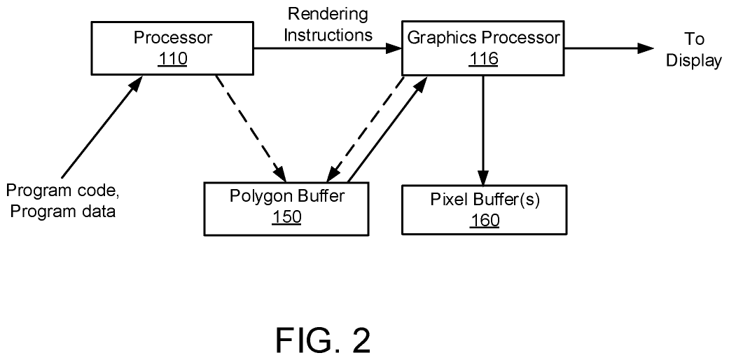

FIG. 2 is a block diagram illustrating processor and buffer interaction, according to one embodiment. As shown in FIG. 2, processor 110 executes program code and program data. In response to executing the program code, processor 110 outputs rendering instructions to graphics processor 116. Graphics processor 116, in turn, reads data from a polygon buffer 150 and interacts with pixel buffer(s) 160 to form an image sequence of one or more images that are output to a display. Alternatively, instead of sending rendering instructions to graphics processor 116 or in addition to sending rendering instructions to graphics processor 116, processor 110 may directly interact with polygon buffer 150. For example, processor 110 could determine which objects are to appear in a view and provide polygon or other mathematical representations of those objects to polygon buffer 150 for subsequent processing by graphics processor 116.

In one example implementation, processor 110 issues high-level graphics commands to graphics processor 116. In some implementations, such high-level graphics commands might be those specified by the OpenGL specification, or those specified by a graphics processor manufacturer.

In one implementation of an image rendering process, graphics processor 116 reads polygon data from polygon buffer 150 for a polygon, processes that polygon and updates pixel buffer(s) 160 accordingly, then moves on to the next polygon until all the polygons are processed, or at least all of the polygons needing to be processed and/or in view are processed. As such, a renderer processes a stream of polygons, even though the polygons may be read in place and be a finite set, where the number of polygons is known or determinable. For memory efficiency and speed, it may be preferable in some implementations that polygons be processed as a stream (as opposed to random access, or other ordering), so that fast, expensive memory used for polygons being processed is not required for all polygons comprising an image.

In some embodiments, processor 110 may load polygon buffer 150 with polygon data in a sort order (if one is possible, which might not be the case where there are overlapping polygons), but more typically polygons are stored in polygon buffer 150 in an unsorted order. It should be understood that although these examples use polygons as the image elements being processed, the apparatus and methods described herein can also be used on image elements other than polygons.

In computer-generated visual content (such as interactive video games), objects may be represented by various computer-generated models, including polygonal meshes and texture maps. A polygonal mesh herein shall refer to a collection of vertices, edges, and faces that define the shape and/or boundaries of a three-dimensional object. A texture map herein shall refer to a projection of an image onto a corresponding polygonal mesh.

Texture mapping provides a method to map colors and other information to pixels from one or more 2D textures to a 3D surface of an object, analogous to “wrapping” a 2D image around the 3D object. In the advent of multi-pass rendering, texture mapping can also include more complex mappings, such as height mapping, bump mapping, normal mapping, displacement mapping, reflection mapping, specular mapping, occlusion mapping, and the like. These techniques make it possible to create near-photorealistic renderings of 3D objects.

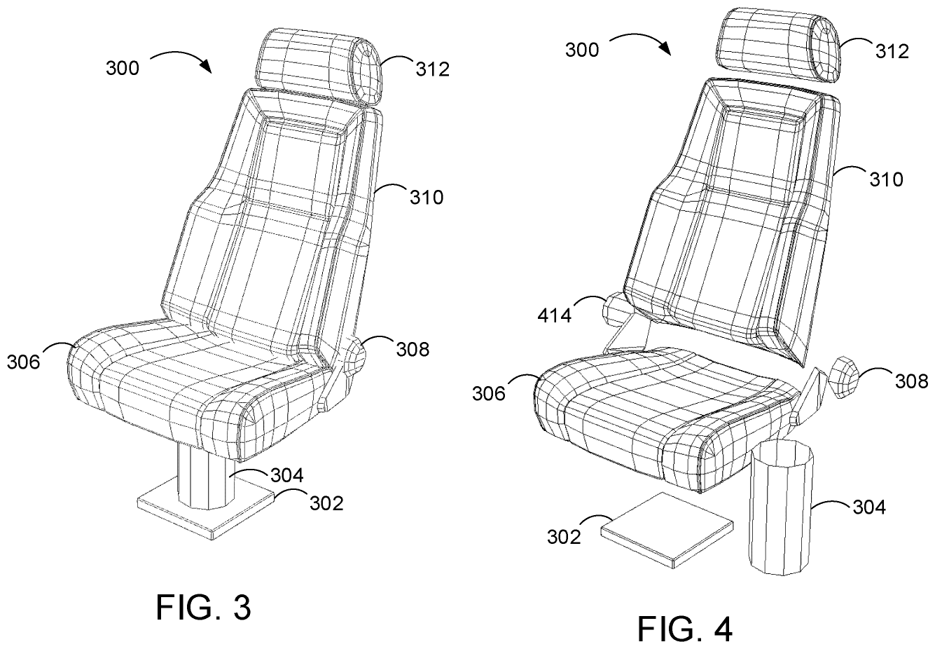

FIG. 3 is an example of a polygonal mesh 300, according to one embodiment. As described, the polygonal mesh 300 is a graphics mesh may correspond to an artist-authored object. In the example shown, the object represents a chair. The polygonal mesh 300 comprises a collection of vertices, edges, and faces that define the shape and/or boundary of the artist-authored object. The faces may include various polygonal shapes, such as triangles, quadrilaterals, convex polygons, concave polygons, regular polygons (e.g., polygons that may have equal length sides and may have equal angles) and/or irregular polygons (e.g., polygons that may not have equal length sides and may not have equal angles).

In various embodiments, the polygonal mesh 300 may be comprised of one or more polygonal sub-meshes, also called “components.” Each sub-mesh may include a series of polygons. In the example shown in FIG. 3, the polygonal mesh is comprised of multiple sub-meshes 302, 304, 306, 308, 310, 312, where sub-mesh 302 represents a chair base, sub-mesh 304 represents a chair post, sub-mesh 306 represents a chair seat, sub-mesh 308 represents a chair handle, sub-mesh 310 represents a chair back, and sub-mesh 312 represents a chair headrest.

FIG. 4 is an exploded view of the object defined by the polygonal mesh 300 shown in FIG. 3, according to one embodiment. The multiple sub-meshes or components are shown in FIG. 4, including sub-mesh 302 that represents a chair base, sub-mesh 304 that represents a chair post, sub-mesh 306 that represents a chair seat, sub-mesh 308 that represents a chair handle, sub-mesh 310 that represents a chair back, and sub-mesh 312 that represents a chair headrest. Also shown in FIG. 4 is a sub-mesh 414 that represents a second chair handle that is not visible in the perspective view shown in FIG. 3, as the second chair handle is occluded by the chair seat and chair back in FIG. 3.

As described above, one or more simplified polygonal meshes, or LODs, can be generated that represent the polygonal mesh 300 to be used in operations to reduce the computational complexity of the operations.

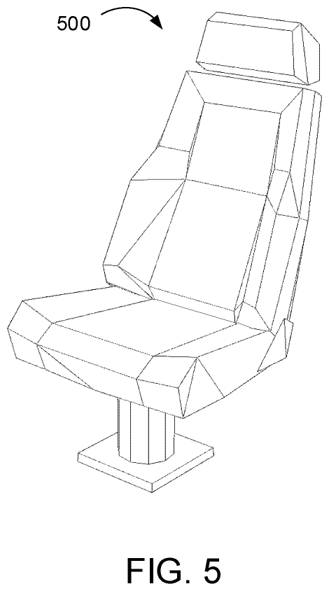

FIG. 5 is an example of a level-of-detail mesh (or LOD) 500 corresponding to the polygonal mesh 300 in FIG. 3, according to one embodiment. As shown, the LOD 500 is a polygonal mesh that includes a smaller number of faces, edges, and vertices compared to the polygonal mesh 300 in FIG. 3. In some implementations, each sub-mesh of the polygonal mesh 300 is simplified individually to generate the LOD 500. The LOD 500 can be used for graphics operations, such as rendering operations, to reduce a resource cost, where, for the case of mesh simplification, a smaller number of polygons in the mesh corresponds to a smaller resource cost. Using LOD 500 for graphics operations allows the polygonal mesh corresponding to the LOD 500 to be stored using less space and may allow a computing device to render the polygonal mesh more easily and may allow a computing device to use fewer computing resources (e.g., using less processing power, less memory, etc.) when rendering the polygonal mesh or to perform shadowing. As a result, the LOD 500 is less expensive to store, process, render, etc. As used herein, the term “resource cost” is used to refer to the cost of computing resources in terms of storage, processing, rendering, etc.

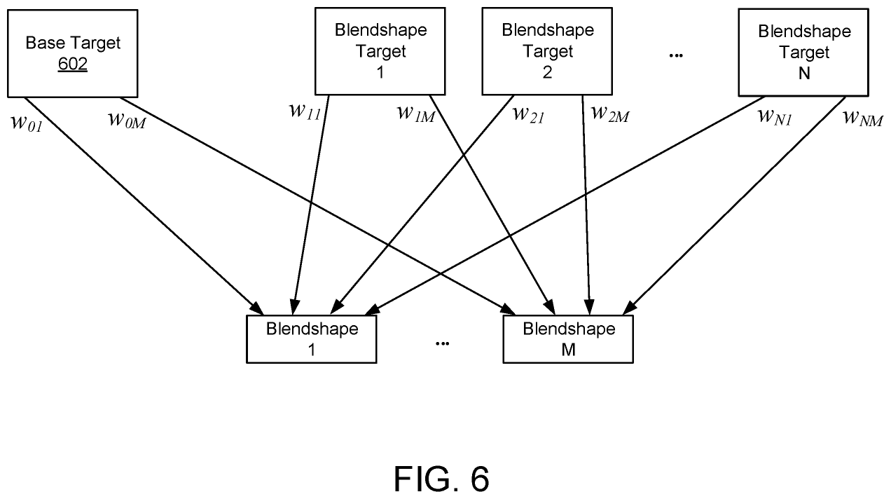

FIG. 6 is a block diagram illustrating a base target 602, blendshape targets 1-N, and corresponding blendshapes 1-M, according to one embodiment. In one embodiment, the base target 602 is a polygonal mesh. The polygonal mesh comprises a collection of vertices, edges, and faces that define the shape and/or boundary of the base target 602. The faces of the polygonal mesh may include various polygonal shapes, such as triangles, quadrilaterals, convex polygons, concave polygons, regular polygons (e.g., polygons that may have equal length sides and may have equal angles) and/or irregular polygons (e.g., polygons that may not have equal length sides and may not have equal angles).

In one implementation, the base target 602 represents a head model. In other embodiments, other parameterized objects are within the scope of the disclosure, such as human bodies, chairs, cars, pets, other parameterizable organic or inorganic things, for example.

In some implementations, the base target 602 representing a head model could include a variety of facial features. Non-limiting examples include face shape, hair style, ears, eyebrows, eyes, nose, cheeks, mouth, chin, jaw, and facial hair, etc. These facial features are merely examples, and some head models may include more or fewer features. Each of the features of the head model can include parameters that are modifiable to customize the appearance of a character rendered from the corresponding head model.

In some embodiments, blendshapes can be used to create additional models based on the base target 602. The blendshapes method is a technique for the creation of realistic and semi-realistic three-dimensional (3D) models and animation. The blendshapes method can deform a neutral shape (for example, an expressionless face) of an object to a desired shape. In embodiments of the disclosure, the base target 602 may represent the neutral shape of a head model. Blendshape targets (i.e., {blendshape target 1, blendshape target 2, . . . , blendshape target N} in FIG. 6) may represent different facial expressions (for example, laugh, frown, pursed lips, closed eyelids, and so forth), different emotions (for example, happy, sad, angry, laughing, crying, scared, surprised, tired, etc.), or different face shape features (for example, thin face, wide face, big nose, big eyes, etc.). In some implementations, each blendshape target 1-N in FIG. 6 deforms only a part of the base target 602 (e.g., left eyebrow raised), or could deform multiple parts of the base target 602 (e.g., to create an expression of a particular emotion).

Blendshapes (i.e., {blendshape 1 . . . blendshape M} in FIG. 6) associated with the base target 602 and blendshape targets 1-N can be formed by blending between the base target 602 and the different blendshape targets 1-N associated with the base target 602. For example, a frown target shape can be mixed with a smile target shape to form a blendshape of apologetic expression, or a target shape with pursed lips can be mixed with a target shape of frowning eyes to form a blendshape of determination or a look of disapproval.

In one implementation, a weight vector can be applied to each blendshape target 1-N (and also, in some embodiments, to the base target 602) to form a blendshape. In an implementation with base target 602 and N blendshape targets, a vector of length N+1 can be used to generate a blendshape, where each weight value of the vector corresponds to a target shape (i.e., the base target 602 or one of the blendshape targets). In some embodiments, two or more blendshapes can be further blended together to generate additional blendshapes.

Although just a single base target 602 and corresponding set of blendshapes are shown in FIG. 6, additional base shapes could be provided with different topologies than the base target 602. These additional base shapes can be associated with different blendshape targets and a different set of blendshapes.

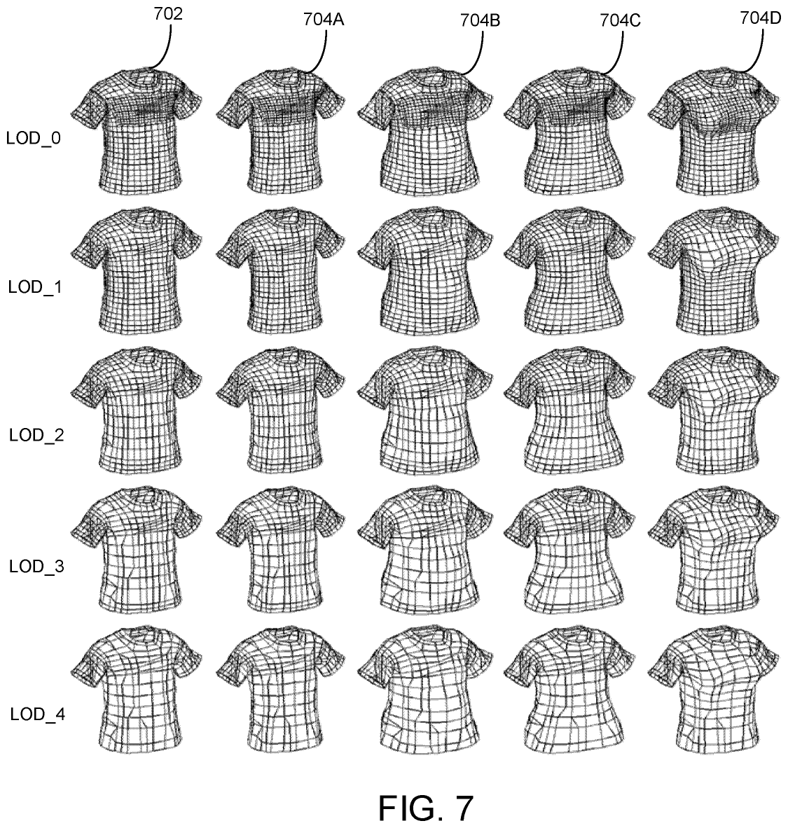

FIG. 7 illustrates a matrix of a base target 702, blendshape targets 704A-704D, and their corresponding LODs, according to one embodiment. In FIG. 7, the base target 702 and the blendshape targets 704A-704D represent LOD_0, i.e., the full-resolution meshes.

The LOD meshes of the base target 702 and the blendshape targets 704A-704D can be visualized as a matrix, as illustrated in FIG. 7, with targets on the horizontal axis and the LODs of each target as columns. The columns represent five targets from a blendshape model of a t-shirt. The base target 702, at far-left, is a generic shape. The other blendshape targets 704A-704D that follow represent different body types.

Each row in FIG. 7 shows a successively less detailed set of LODs of the targets. The rows are referred to by index as LOD_0, LOD_1, LOD_2, LOD_3, and LOD_4, with LOD_0 (i.e., the top row) being the full-resolution reference version of each target. The corresponding LOD meshes of different targets (i.e., the meshes in each row) have identical topology, matching the topology of the left-most base target. Successive LOD meshes of each target (i.e., the meshes in each column) have similar geometry, matching the geometry of the LOD_0 reference mesh of that target, at the top of the column.

### Stored Normals and Shading

In a polygonal mesh representing a 3D object, given a vertex in a polygonal face, a geometric normal, or normalized unit direction vector, can be computed representing the orientation of the face at that vertex. The normal can be computed as the cross-product of the directions of the pair of successive edges incident to that vertex, in the face, normalized to unit length.

The normals associated with face vertices are used during shading calculations that occur during rendering. In some implementations, when faces are non-triangular, the faces are triangulated prior to rendering. Each triangle is rendered independently, using the normals associated with its vertices.

Although geometric normals can readily be computed for meshes as needed, in practice it is common to store precomputed normals on the mesh. Doing so allows explicit control over how models are shaded when rendered. The stored normals are used in place of directly computed geometric normals during rendering.

When a triangle is rendered, the stored normals at its three vertices are interpolated per-pixel across the triangle, using, for example, linear interpolation, and each pixel is shaded using the interpolated normal value at that pixel.

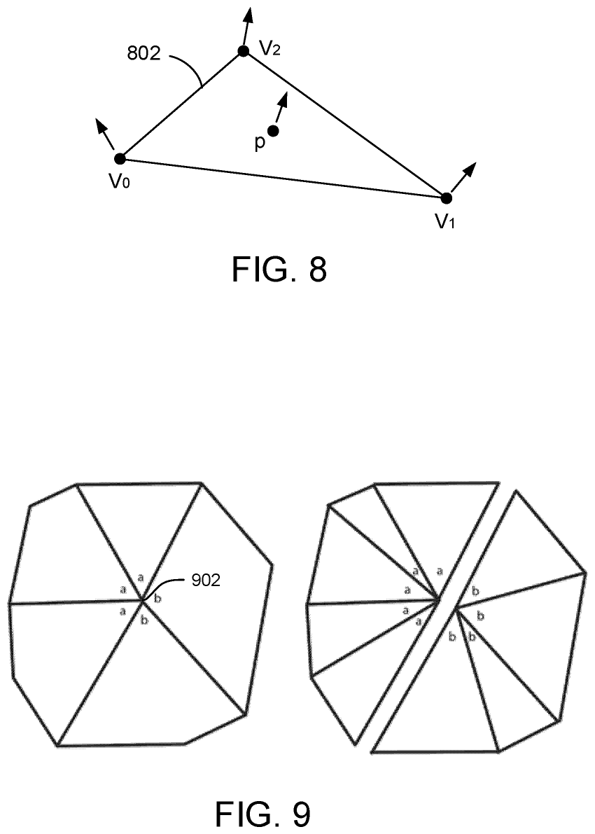

FIG. 8 is a conceptual diagram illustrating a face 802 of a polygonal mesh, in one embodiment. The face 802 includes vertices v₀, v₁, and v₂. In FIG. 8, the normals for the face 802 that are stored at the vertices v₀, v₁, and v₂ are represented by directional arrows. To compute a normal for a point p in the face 802, the stored normals at the vertices v₀, v₁, and v₂ are interpolated across the triangle.

Storing pre-computed normals allows the use of normal values that are independent from those calculated directly from the geometry. By precise control over the normals stored at face-vertices, it is possible to make the flat surfaces of rendered triangles appear curved. In practice, each triangle is flat, and only the normals vary. This interpolation of stored normals is useful for efficient rendering, in that storing normals allows a smooth curved surface to be convincingly approximated by relatively large mesh faces that only roughly approximate its smooth shape, in piecewise-planar fashion.

In some embodiments, rendering of blendshapes relies on being able to blend between the positions of vertices at identical offsets within identically sized vertex buffers, for the different target meshes. For that reason, the blendshape target meshes must have exactly identical topology throughout the whole rendering pipeline. Therefore, corresponding faces in corresponding LODs for different blendshape targets have identical face indices and reference corresponding vertices, with identical vertex indices.

In addition, mesh normals, texture coordinates (UVs), and colors on the different meshes must not cause corresponding vertices to be split differently in corresponding LOD meshes of different blendshape targets. A vertex will be split prior to rendering if the faces (or triangles) incident to it have different UVs, normals, or colors, at that vertex. Each rendered vertex must have exactly one value for each provided set of UVs, normals, and colors. Hence, if two different faces share the same vertex, yet have different property values at the vertex, then the vertex is split such that each copy of the vertex is referenced only by faces with a single consistent value for each such property.

FIG. 9 illustrates a portion of mesh with different UV values for a vertex of the mesh, in one embodiment. Vertex 902 in the mesh is surrounded by five faces that are a mixture of triangles and quads. The incident faces have, between them, two unique UV values at the vertex, shown as “a” and “b.” This happens, for example, at vertices that lie on the boundaries of different UV islands, i.e., disconnected sets of faces in UV space. Prior to rendering, any non-triangular faces are triangulated, since hardware rendering is traditionally triangle-based. In addition, the vertex 902 is split such that triangles that have different UVs at the vertex end up referencing different vertices, as shown on the right side of FIG. 9. The effect is to create disconnected submeshes such that each submesh is textured consistently. Similar splits happen with other face-vertex properties, such as normals and colors.

As described above, because corresponding LODs of different blendshape targets must have identical topology, standard LOD generation tools cannot be used to naively generate LODs for each blendshape target independently in turn. Since the simplification operations performed depend on the geometry of the mesh, LODs generated for different targets independently are likely to have different topology.

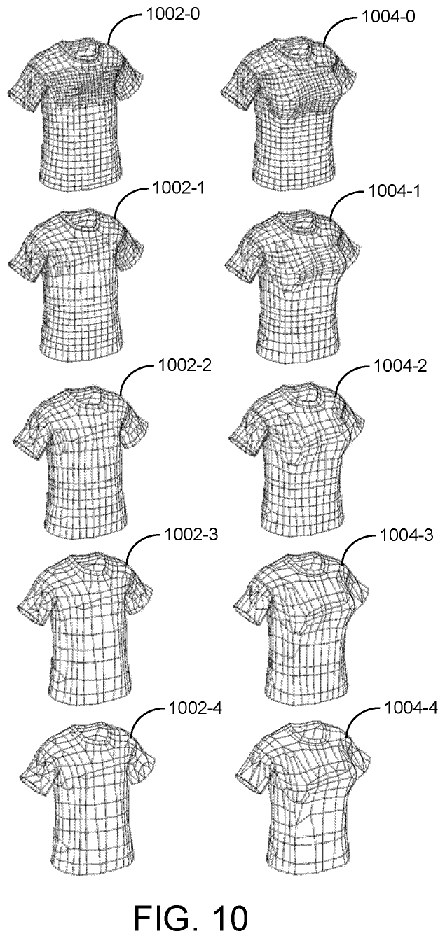

FIG. 10 illustrates a base target 1002-0, a blendshape target 1004-0, and LODs of the base target 1002-0 and the blendshape target 1004-0, according to one embodiment.

The left column in FIG. 10 illustrates base target 1002-0 and LODs 1002-1 to 1002-4 generated for base target 1002-0. The right column in FIG. 10 illustrates blendshape target 1004-0 and LODs 1004-1 to 1004-4 generated for blendshape target 1004-0. In the example shown in FIG. 10, the LODs for the base target 1002-0 and the blendshape target 1004-0 are generated independently. Note how equivalent LODs (in the same row) have different topology. Intuitively, LODs generated for the blendshape target 1004-0 (representing a chest blendshape target) are likely to retain more edges in the chest area, where geometry is required to represent the more complex shape. Considered in isolation, the extra geometry in this area seems redundant in the base target and is quickly removed when the mesh is simplified. However, as noted above, for rendering using blendshapes, the meshes of each blendshape target at a given LOD level must have the same topology.

Manually authoring a full set of LODs for each blendshape target, and ensuring topological consistency between them, is a tedious challenge using traditional workflows. If LOD meshes for two different blendshape targets differ by even a single vertex, the whole blendshape model cannot be used. As a result, early prototyping opportunities and iteration times suffer. Additionally, if later edits are made to a previously authored blendshape, any such edits must be painstakingly made in consistent fashion to the corresponding LOD meshes of all targets.

### Mesh Simplification

According to various embodiments, mesh simplification includes iteratively applying one or more simplification operators to a mesh. Each application of a simplification operator reduces the topological complexity of the mesh. Some embodiments apply an edge collapse operator, which collapses an edge of the mesh to a single vertex, as shown in FIG. 11.

In FIG. 11, an edge 1102 of a mesh connects two vertices labelled v0 and v1. Collapsing the edge 1102 replaces it with just a single collapse vertex, notionally picked arbitrarily from the two—in this case v0. The retained vertex v0 is moved to a new location called the collapse point.

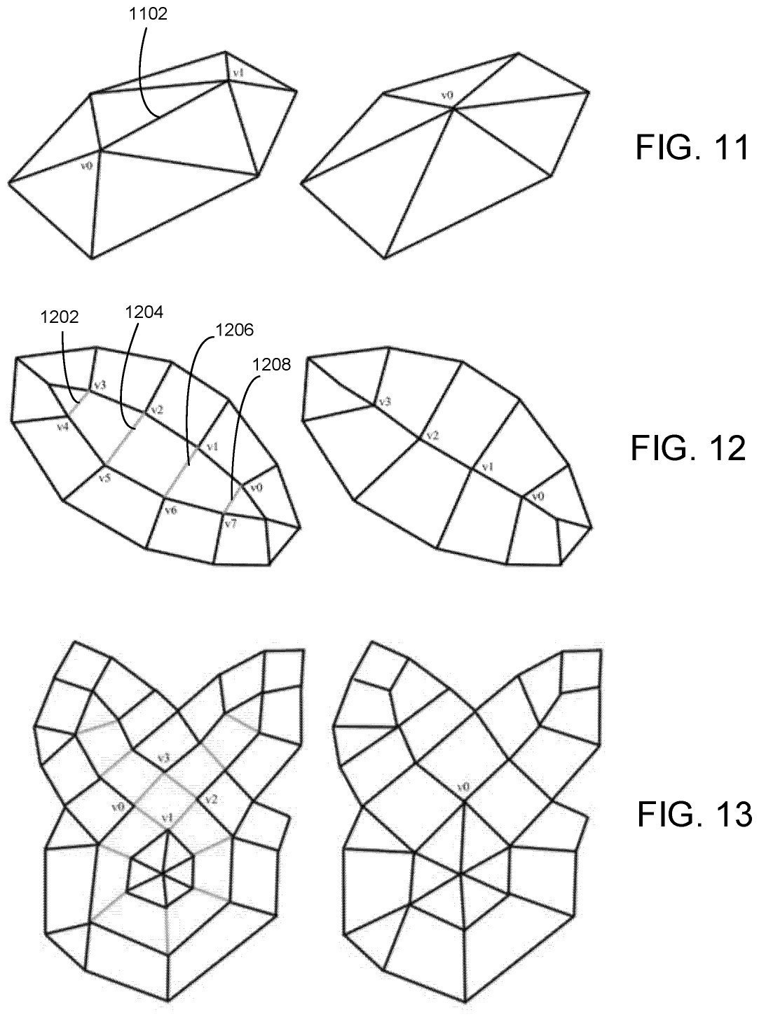

To better preserve the regularity of quad meshes, some embodiments use a generalization called polychord collapse, in which multiple edges are collapsed together, in a single operation, as shown in FIG. 12.

In some embodiments of polychord collapse, edges are chosen to neatly collapse entire quad strips (i.e., sequences of quad faces connected by shared edges) or sometimes shorter sequences of quad faces within longer strips. The sets of edges collapsed are those that separate the collapsed quads.

FIG. 12 illustrates a mesh with edge 1202 (connecting vertices v3 and v4), edge 1204 (connecting vertices v2 and v5), edge 1206 (connecting vertices v1 and v6), and edge 1208 (connecting vertices v0 and v7). Edges 1202, 1204, 1206, 1208 of a quad strip (terminated by triangles) constitute a polychord. Collapsing the polychord includes collapsing all of its edges 1202, 1204, 1206, 1208, in a single operation, as shown in FIG. 12.

In some embodiments, where quad strips self-intersect, multiple edges in the set can be connected by shared vertices. Where this happens, some embodiments identify “islands” of connected edges. In general, an island is a subset of the edges in a polychord that share vertices—often each island is just a single edge. Each identified island of edges can be collapsed to a single collapse vertex located at a point in space called the collapse point of that island.

FIG. 13 illustrates a self-intersecting polychord, in one embodiment. In FIG. 13, the polychord self-intersects (crosses itself), with the result that edges (v0, v1), (v1, v2), (v2, v3), and (v3, v0) are connected at vertices v0, v1, v2 and v3, forming a non-trivial island. The entire island can be collapsed to a single collapse vertex, picked from among the island vertices - in this case v0. The collapse point is chosen to optimize the geometric fidelity of the collapsed geometry to the original.

The purpose of edge collapse is to reduce the topological complexity of the mesh by collapsing the faces incident to each collapsed edge. In that sense, edge collapse is a topological operation. Still, it is both influenced by the geometry of the mesh, and optimized to best preserve that geometry. Edge collapse operations choose carefully which edge/polychord to collapse next, selecting the edge/polychord that optimizes the least impact on the fidelity of the mesh with a greater reduction in the complexity of the mesh (e.g., number of triangles). When collapsing an edge/polychord, some embodiments choose carefully the collapse points of the collapse vertices that replace the islands of collapsed edges, picking points which best preserve the local shape of the mesh.

Some embodiments for edge collapse use a technique based on a mathematical construct called a quadric. A quadric is a quadric equation that in 3D can be represented efficiently by a matrix, a vector, and a scalar. Such a quadric is associated with each vertex of the mesh. The quadric stored with each vertex can be thought of as remembering a set of planes, weighted by area or importance, on which the vertex should ideally lie. From the quadric associated with a vertex, some embodiments can compute both a cost metric estimating the geometric infidelity of any arbitrary candidate location for the vertex, and an optimal location for the vertex.

Initially, the quadric associated with each vertex is just the combination of the planes of the faces incident to that vertex. Naturally the location of the vertex satisfies this initial quadric optimally, with a cost of zero.

When considering the collapse of an island of connected edges, some embodiments sum the quadrics associated with the vertices of the island. Summing quadrics can be thought of as combining the sets of planes remembered by the respective quadrics. From this summed quadric, some embodiments can compute an optimal location, or collapse point, for the single collapse vertex that would replace the island after collapse. Then some embodiments query the quadric to estimate the cost of that proposed collapse point. Typically this cost is non-zero, since a single vertex generally cannot optimally satisfy all of the planes in the combined set.

Some embodiments have the option of proposing a different collapse point—to satisfy some other requirement—and evaluating the cost of this new point instead. Some embodiments use this approach, in particular, to smooth collapse points so that the edges of the collapsed mesh still form smooth edge loops.

In some embodiments, the available polychord collapse candidates are stored in a priority queue, and the queue is used to drive iterative simplification. The candidates are prioritized by descending “value,” where the value of a candidate is the ratio of its benefit (for example, number of triangles removed from the mesh) to its cost (for example, the sums of the predicted quadric costs of the islands of connected collapse edges representing a change in geometric fidelity).

In some embodiments, candidate collapses may be rejected if they are found to be unsuitable for one reason or another. Some collapses may be topologically degenerate, in the sense that performing them would collapse two edges on different sides of the mesh, making the merged edge no longer locally two-manifold.

Other candidate collapses that may be rejected are those that may be geometrically degenerate, or simply undesirable, because their proposed collapse points would invert faces of the mesh or make some previously convex faces concave. Such geometrically undesirable collapses can either be rejected outright or penalized in the cost metric. Some embodiments use a variety of different cost terms to penalize different kinds of undesirable collapses. In some embodiments, a total cost metric for a collapse is a sum of the various cost terms.

To perform simplification, some embodiments repeatedly pick the available collapse candidate at the front of the queue, i.e., the collapse with greatest value, and execute the collapse. This consists of collapsing each of the islands of connected edges to just its collapse vertex, and moving the collapse vertex to its computed collapse point. When executing a collapse, the candidate collapse queue is updated to remove any candidates that no longer reflect the new state of the mesh, or whose costs may have changed, and then insert any new candidates, with updated cost estimates. This iterative simplification continues, one collapse at a time. The LOD meshes are created by copying out snapshots of the mesh, as their triangle budget thresholds are met. The iteration ends when all LODs have been created, or when the candidate collapse queue is exhausted.

Some embodiments set the quadric of each new collapse vertex to the sum of the quadrics of the vertices of its island. Since summing quadrics can be thought of as combining their remembered sets of planes over the course of successive collapses, the quadric of each collapse vertex can be thought of as remembering a progressively larger area of the original mesh, i.e., the planes of all incident faces of all the vertices that were collapsed to form it.

Some embodiments also update the normals of the faces incident to collapse vertices. The normals around each collapse vertex are re-averaged (summed and re-normalized), being careful to retain any previously existing hard edges (where normals around a vertex differ). Likewise, the UVs of the faces incident to collapse vertices are updated, typically computing new interpolated UV values at the collapse points, but being careful to preserve the locations of any existing UV boundaries (where UVs around a vertex differ).

### Generate Operator

In some embodiments, the Generate operator uses the quadric polychord collapse mesh simplification technique described earlier, generalized to simplify multiple related mesh geometries on a single shared topology.

Whereas mesh simplification traditionally operates on a single mesh, with a single topology and a single geometry (shape), some disclosed embodiments operate on a series of meshes (or targets) at once, such as separate blendshape targets. Because at each LOD level we cannot allow different simplification operations to be performed on the different meshes, the same simplification operations are performed on all the blendshape target meshes. One embodiment for doing this type of simplification would be to synchronize the operations, arranging to perform the same operation in all blendshape target meshes, in lock-step. Another embodiment stores only one mesh, with a single topology, and associates multiple geometries with that single mesh.

In such an embodiment, a single mesh (for example, a base target mesh) stores multiple vertex position properties and multiple face-vertex normal properties, or attributes. One embodiment exploits a half-edge representation to create and store multiple properties of the same kind, indexed by an integer index.

At input time, some embodiments read the LOD_0 mesh of the base target. When reading the LOD_0 meshes of the other blendshape targets, instead of creating new meshes for them, we copy their positions and normals to successive properties on the single mesh already created for the LOD_0 mesh of the base target. The resulting mesh has a single topology but multiple geometries.

During simplification, LODs are copied out as snapshots of the simplified mesh at specific triangle budgets, as before. When a LOD mesh is created, we create multiple instances of it, one for each target, using the appropriate position and normal property for that geometry.

As such, some embodiments generalize the quadric polychord collapse operator. The generalized operator acts on a single mesh, collapsing edges within the topology of that mesh, as before. However, where the standard operator computes a single collapse point for the collapse vertex of each island, the generalized metric must compute an independent collapse point for each geometry. The collapse points of the different geometries can be computed independently. Note that the collapse points computed for different geometries will in general be different, since they depend on the shapes of the faces around the collapsed edges, in each geometry.

To that end, we also compute and store a separate quadric for each geometry, at each vertex. Some embodiments use multiple custom vertex properties of quadric type, with successive numeric indices, to associate multiple quadrics with each of the vertices of the mesh. These quadrics are initialized as before, representing the planes of the faces incident to the vertex, but independently for each geometry. The initial quadric values of a single vertex will in general be different, since the planes and sizes of the incident faces will tend to differ in the different geometries.

When computing the collapse point of an island in each geometry, embodiments of the disclosure sum the quadrics of the island vertices in that geometry, and use the summed quadric to compute an optimal collapse point, as before. Any extra steps to tweak the locations of collapse points, for example to smooth edges in the collapsed mesh, are performed independently for each geometry.

Previous approaches computed a single cost estimate for each collapse island, estimating the geometric error introduced by replacing all the connected edges in the island with a single vertex located at the computed collapse point. In the disclosed generalized operator according to embodiments of the disclosure, we need to compute a separate cost estimate per geometry. The multiple per-geometry cost estimates of each island can be combined, for example by taking the mean. Optionally, some embodiments could also take a weighted mean, weighting some important blendshape targets more heavily than others.

Various other cost metric terms that depend on the geometry of the mesh can also be generalized. Such other cost metrics can be computed independently for each geometry, then combined. As a specific example, some embodiments penalize collapses that make previously convex faces concave. In the generalized operator, we compute the penalty in each geometry independently, and then take the mean. Alternatively, some embodiments may take the maximum penalty across all geometries, to ensure that penalties are not diluted within the mean.

Topologically degenerate collapses, which would make the mesh locally non-manifold, are rejected, as before. Since this check depends only on topology, it need only be performed once per collapse, rather than independently for each geometry.

Candidate collapses are still inserted into a single priority queue, ordered by descending value. The value of a candidate is computed as the ratio of its benefit to its cost, as before. The difference is that some of the cost terms of which the cost estimate is a sum, are means (or maximums, in some embodiments) of estimates computed independently for each geometry.

When a candidate collapse is picked from the queue and executed, the positions of the collapse vertices are updated in each geometry in turn, using the collapse points computed for that geometry. The quadrics of the collapse vertices are also updated. In the disclosed generalized operator, the quadric of each geometry is set to the sum of the per-vertex quadrics computed in that geometry.

Face-vertex normals are stored separately in each geometry, and so are updated for each geometry in turn. Some embodiments also ensure that normals are handled consistently across geometries, so that different vertex splits are not introduced. Some embodiments determine the handling of normals once, using one of the normal values of one geometry picked arbitrarily (e.g., the base target mesh). This reference geometry is used to detect and preserve existing hard edges around vertices after collapse. This assumes that an edge that is hard-shaded in one geometry will be hard in all of them, which follows from the requirement that vertices are split consistently.

Face-vertex UVs and colors, on the other hand, are stored once and not replicated per-geometry. These can simply be updated as usual.

### Morph Operator

Unlike the Generate operator, the Morph operator bears no relation to traditional mesh simplification. Instead of simplifying meshes to move downwards in the matrix (as shown in FIG. 10) from more-detailed to less-detailed LODs, morphing meshes generates meshes sideways across the matrix from LODs of the base target (in the left-most column in FIG. 10) to corresponding LODs of other targets (in the other columns in FIG. 10).

Some embodiments morph LODs for each target separately. When morphing a LOD of the base target to produce a corresponding LOD of another blendshape target, we want to produce a mesh that has the topology of the base target LOD, but geometry matching the shape of the destination blendshape target. The LOD_0 meshes of the blendshape targets are used as geometry references, defining the shapes of the different targets.

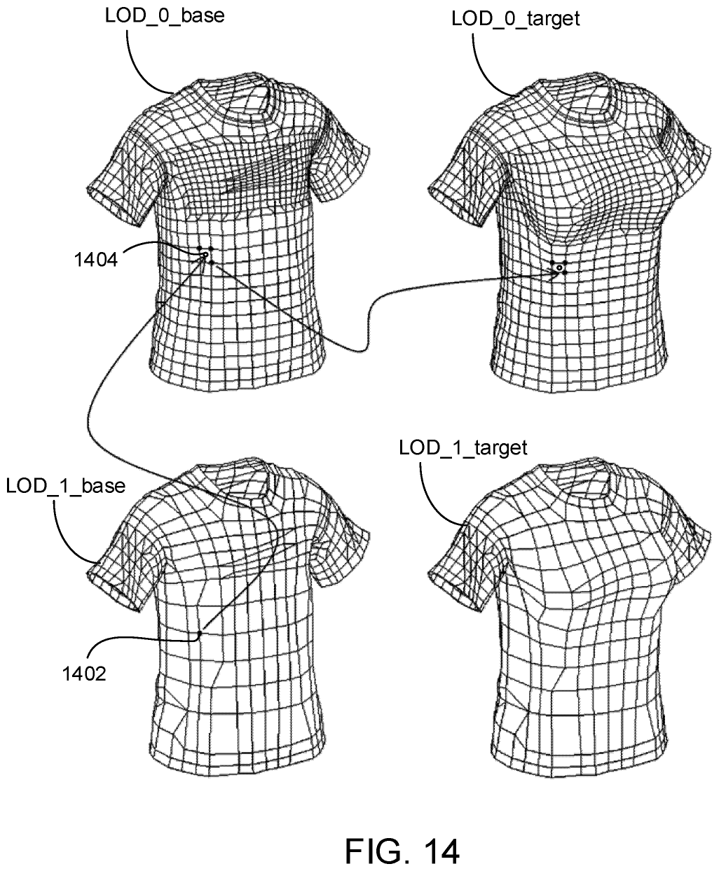

FIG. 14 illustrates using the Morph operator to generate a LOD for a blendshape target, in one embodiment. At top-left is the LOD_0 mesh of the base target (LOD_0_base), which defines the shape of the base target. At the top-right is the corresponding LOD_0 mesh of a destination target (LOD_0_target), in this case a chest target, which defines the shape of the destination blendshape target. At the bottom-left is a less-detailed LOD of the base target (LOD_1_base), which is the input to the Morph operator. Finally, at the bottom-right, a corresponding LOD of the destination target is shown (LOD_1_target), which is the output to the Morph operator.

Some embodiments generate the LOD_1_target mesh from the LOD_1_base mesh by morphing the input mesh (LOD_1_base) to take on the shape of the destination target as defined by the LOD_0_target. Note that the mesh the Morph operator is trying to generate has the topology of the corresponding LOD of the base target (LOD_1_base), but the shape of the LOD_0 mesh of the destination target (LOD_0_target).

Given the input LOD of the base target (LOD_1_base), we start by making a copy of the base target, preserving the same topology. Note that when making the copy, the indices of the faces and vertices are conserved. If a vertex has a certain index in the original mesh, the corresponding vertex in the copy mesh has the same index, and so on. We then need to move each of the vertices of the copy mesh to new positions that will, together, take on the shape of the destination target.

For a given vertex 1402 in the LOD_1_base mesh, some embodiments first map the vertex 1402 to a point 1404 on the base target (LOD_0_base). A first correspondence map is used for this purpose that maps vertices on the input LOD to corresponding points on the LOD_0 mesh. Using that map, we can determine the point in the LOD_0 mesh which corresponds to each vertex of the input LOD.

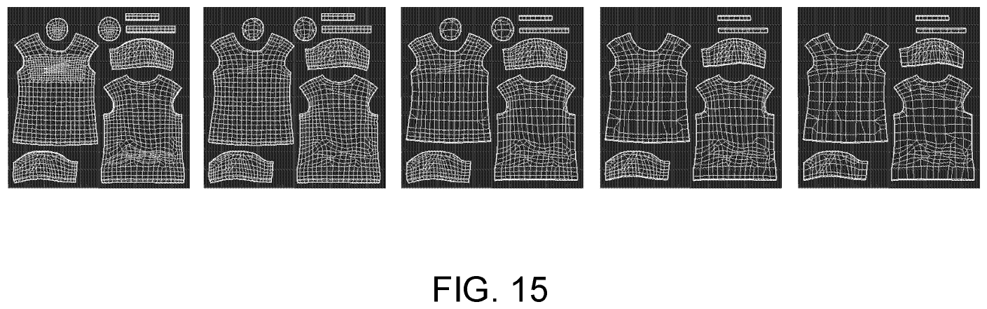

In some embodiments, different LODs of the same target mesh do not share the same topology, so simple vertex index lookups do not work for this mapping. However, some embodiments exploit the fact that the different LODs of the same target mesh have the same texture, and so share a consistent UV mapping. This is illustrated in FIG. 15, which compares the UV maps of five LODs of the base target.

FIG. 15 illustrates the UV islands of the different LODs that are topologically different, in one embodiment. As shown in FIG. 15, the different UV islands read the same texture, in a consistent way, and so provide a correspondence map between LODs. As such, corresponding points on different LODs have the same UV values.

Therefore, given a vertex 1402 of the input LOD, we can look up the UV coordinates of that vertex, then search the faces of the LOD_0 mesh of the same target for a triangle (or, in some embodiments, face) whose UVs best contain the UV coordinates of the vertex 1402. By computing the areal (barycentric) coordinates of that point 1404 in UV space with respect to the triangle formed by the UVs of the three triangle vertices (as shown in FIG. 14), and then using those areal coordinates to compute an interpolated point on the 3D triangle, we can find equivalent points. The areal coordinates are linear parameters applied to the UVs, or positions, of the three vertices.

Once point 1404 is determined on LOD_0 of the base target (LOD_0_base), the next step is to determine a corresponding point on the LOD_0 of the destination target (LOD_0_target) using a second correspondence map.

To build the second correspondence map, we exploit the fact that corresponding LODs of different targets have identical topology, including their vertex indices. Given a vertex in one, we can easily find the corresponding vertex in another, using the index of a vertex in one mesh to look up the corresponding vertex in a second.

Therefore, given point 1404 on the surface of one mesh, we can search for a triangle on that mesh (three vertices in a face, as shown in FIG. 14) that contains that point, and then identify a corresponding triangle on the LOD_0 mesh of the destination target (LOD_0_target) using vertex index lookup. If we compute the areal coordinates of the point 1404 within the first triangle, we can find the corresponding point in the second by applying the areal coordinates to those vertices instead.

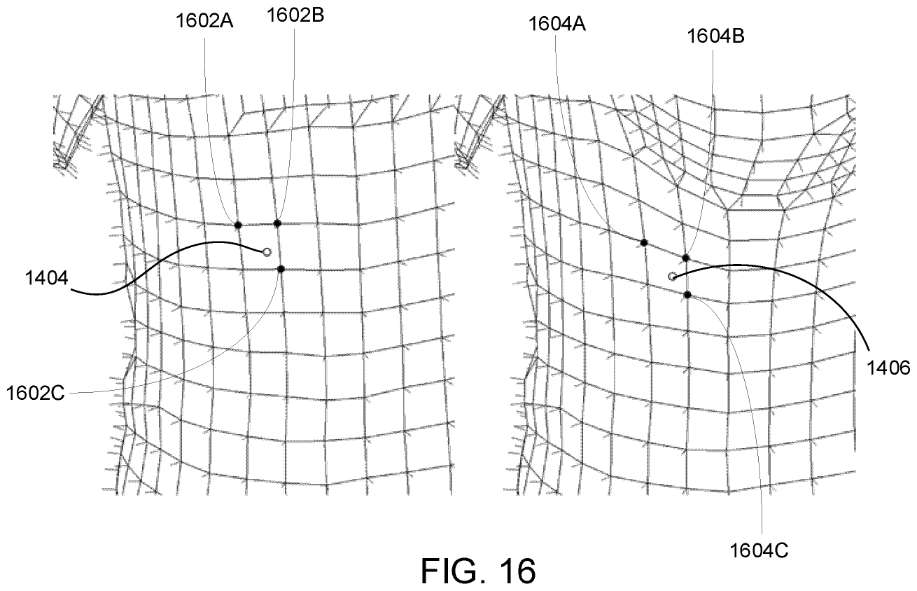

FIG. 16 illustrates a point 1404 on a base target and corresponding point 1406 on a destination target, in one embodiment. For point 1404, three highlighted vertices in the base target mesh (on the left) are mapped to the equivalent three highlighted vertices in the destination target with identical vertex indices (on the right). Corresponding points 1404 and 1406 within the triangles are shown as outline dots. The two points 1404 and 1406 have identical areal coordinates with respect to their containing triangles.

Some embodiments then determine the respective translations between the three vertices identified in the base target (LOD_0_base) and the three vertices identified in the destination target (LOD_0_target). For example, the determined translations are between vertex 1604A and vertex 1602A, between vertex 1604B and vertex 1602B, and between vertex 1604C and vertex 1602C. The three determined translation amounts can be aggregated, for example by taking their mean or by areal interpolation

Similarly, some embodiments then determine the respective rotations between the three vertices identified in the base target (LOD_0_base) and the three vertices identified in the destination target (LOD_0_target). Each vertex is associated with a face normal. Thus, the determined rotations are between face normals of vertex 1604A and vertex 1602A, between face normals of vertex 1604B and vertex 1602B, and between face normals of vertex 1604C and vertex 1602C. The three determined rotation amounts can be aggregated, for example by areal interpolation.

Once the aggregated translation amount and aggregated rotation amount are determined, these values can be applied to the vertex in the copy of the input base mesh LOD to transform the corresponding vertex in the copy. This process can be repeated for each vertex of input base mesh LOD to morph the input base mesh LOD into a LOD for the blendshape target.

In summary, the Morph operator computes, for a given vertex in the input LOD, the correct location and orientation of that vertex in the generated output LOD by performing the following steps:
1. Look up the UVs of the vertex of the input LOD of the base target.
2. Search the LOD_0 mesh of the base target for a triangle of three vertices whose UVs contain those UVs, in UV space.
3. Compute the areal coordinates of the UV coordinates within the triangle, in UV space.
4. Locate the three corresponding vertices of the LOD_0 mesh of the destination target, with identical vertex indices, forming a triangle within that mesh.
5. Compute three translations between the positions of each of the three triangle vertices, in the respective LOD_0 meshes.
6. Compute three rotations between the orientations of the surface normals at each of the three triangle vertices, in the respective LOD_0 meshes.
7. Blend the three translations, for example by using the computed areal coordinates, to compute a single aggregated translation.
8. Blend the three rotations using the computed areal coordinates, to compute a single aggregated rotation.
9. Transform the position of the corresponding vertex in the output mesh by the blended translation.
10. Transform the normals at the corresponding vertex in the output mesh by the blended rotation.

Because UV coordinates are properties of face-vertices (i.e., vertices of faces) rather than of vertices themselves, looking up the UV coordinates of a vertex actually means looking up the UV coordinates of that vertex in one or more of the faces incident to the vertex. In general, the faces may assign different UV coordinates to the vertex. This can happen at the boundaries of UV islands, where regions of the mesh with different UV mappings meet. In practice, the incident faces share one or more unique UV values, with several adjacent faces around the vertex sharing one of the unique values. Faces with different UVs are separated by edges that are boundaries of UV islands. In cases where the vertex is on a UV island boundary (so has more than one unique UV value in its incident faces), some embodiments pick one of the unique UV values at random, and other embodiments test each of them in turn and average the results.

It can happen that multiple 3D faces on the LOD_0 mesh are mapped to the same UV island. In one implementation, portions of a mesh that are repeated can be textured with the same area of a texture, so they reuse the same UV islands to save texture space.

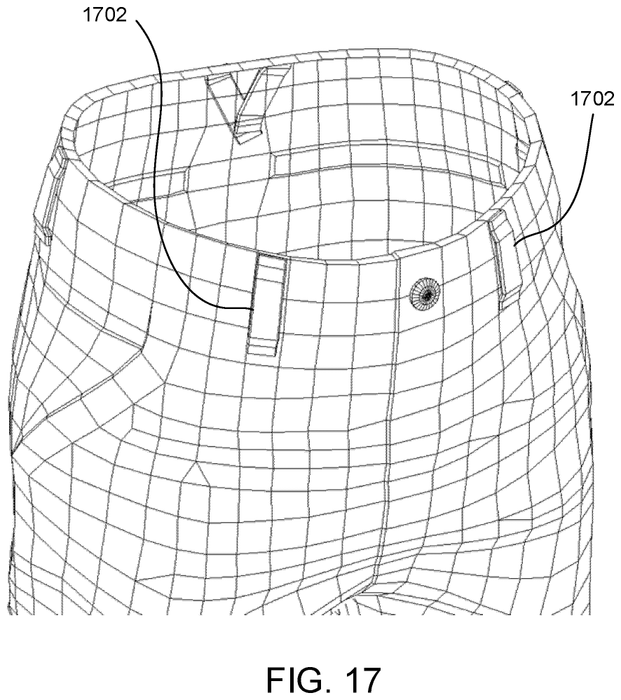

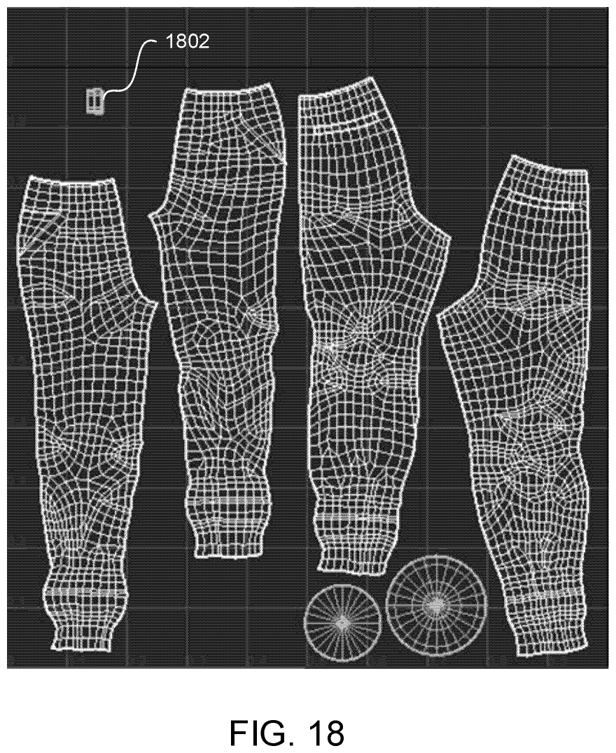

FIG. 17 is an example of a mesh representing trousers, in one embodiment. FIG. 18 is an example of the UV layout for the trousers, in one embodiment.

As shown in FIG. 17, a belt loop mesh 1702 is repeated multiple times in the overall mesh. Referring to FIG. 18, there is only one pair 1802 of UV islands for the belt loops (e.g., one for the outer surface, one for the inner surface). A single copy of each island is referenced by each belt loop mesh 1702 on the 3D model. Because of this sharing of UV islands by each belt loop mesh 1702, in some cases, the UVs of multiple 3D faces contain the UV coordinates of a given vertex. When trying to map one of the vertices of one of the loops in the input LOD, in some implementations, multiple faces of the corresponding LOD_0 mesh have UVs that contain the UVs of the vertex. Some embodiments can disambiguate them, finding the 3D faces on the correct belt loop, by comparing the 3D coordinates of the matching faces and picking the nearest in 3D space.

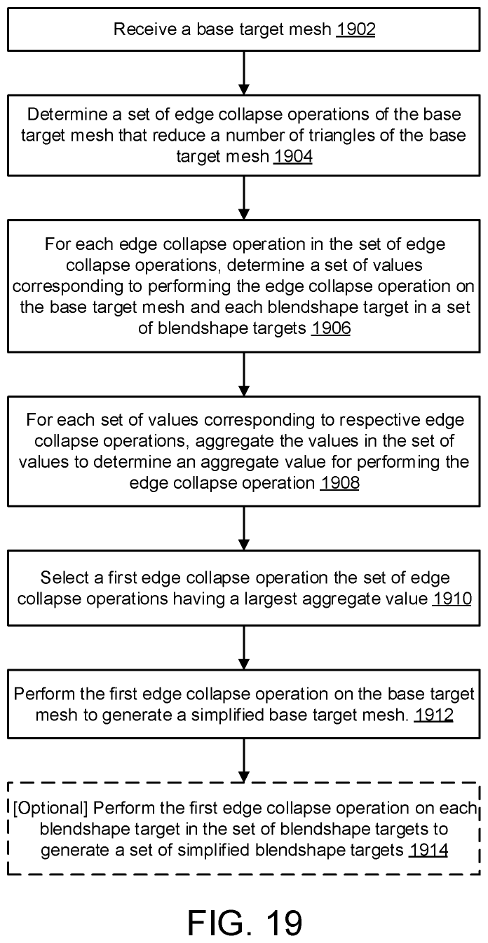

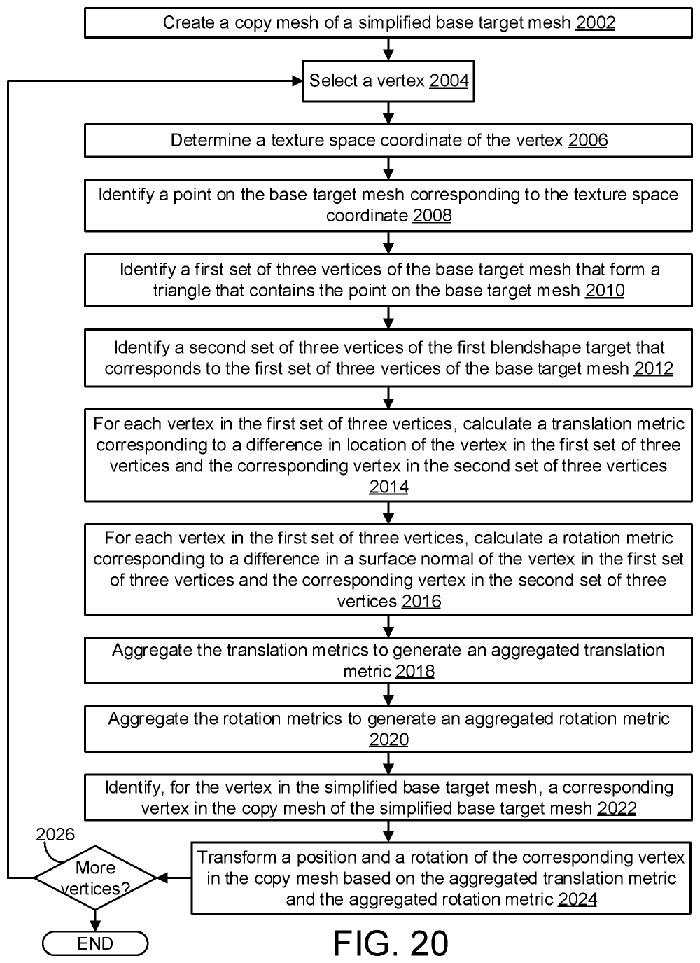

FIG. 19 is a flow diagram of method steps for simplifying a mesh, according to one embodiment. In various implementations, the method can be performed by the processor 110, the graphics processor 116, or a combination of the processor 110 and the graphics processor 116. In some embodiments, two or more steps shown in FIG. 20 may be performed by the same process or at the same time or in a different order.

As shown, the method begins at step 1902, where the processor receives a base target mesh. The base target mesh could be, for example, a full-resolution base target mesh, such as base target mesh 702 shown in FIG. 7. The base target mesh is a polygonal mesh having a first topology. The base target mesh is also associated with a set of blendshape targets that can be used to deform the base target mesh, such as blendshape targets 704A-704D in FIG. 7. The base target mesh and each blendshape target in the set of blendshape targets has the same topology (i.e., same number of vertices, face, edges). Also, each blendshape target in the set of blendshape targets has a different geometry, where each different geometry comprises different locations of the vertices in the common topology.

At step 1904, the processor determines a set of edge collapse operations of the base target mesh that reduce a number of triangles of the base target mesh. As described above, in some embodiments, single-edge or polychord collapse operations can be used. Some degenerate collapses may be disqualified and not included in the set of edge collapse operations.

At step 1906, for each edge collapse operation in the set of edge collapse operations, the processor determines a set of values corresponding to performing the edge collapse operation on the base target mesh and each blendshape target in a set of blendshape targets. Each value in the set of values is based on a cost metric and a benefit metric of performing the edge collapse operation on the base target mesh or a respective blendshape target in the set of blendshape targets.

In some embodiments, the cost metric of performing a given edge collapse operation on the base target mesh or a given blendshape target in the set of blendshape targets corresponds to a change in geometric fidelity of the base target mesh or the given blendshape target based on performing the given edge collapse operation.

In some embodiments, the benefit metric of performing the given edge collapse operation on the base target mesh or a given blendshape target in the set of blendshape targets corresponds to a reduction in a number of triangles of the base target mesh or the given blendshape target based on performing the given edge collapse operation.

At step 1908, for each set of values corresponding to respective edge collapse operations, the processor aggregates the values in the set of values to determine an aggregate value for performing the edge collapse operation on the base target mesh and each blendshape target in the set of blendshape targets. In some embodiments, aggregating the values in the set of values to determine the aggregate value for performing the given edge collapse operation comprises calculating a mean value of the values in the set of values for performing the given edge collapse operation on the base target mesh and each blendshape target in the set of blendshape targets.

At step 1910, the processor selects a first edge collapse operation the set of edge collapse operations having a largest aggregate value (i.e., best cost/benefit value).

At step 1912, the processor performs the first edge collapse operation on the base target mesh to generate a simplified base target mesh.

At step 1914, the processor performs the first edge collapse operation on each blendshape target in the set of blendshape targets to generate a set of simplified blendshape targets. In some embodiments, step 1914 is optional. As such, because the same edge collapse operation is performed on the base target mesh and each blendshape target, the topology of the simplified base target mesh and each simplified blendshape target is the same.

In some embodiments, the method shown in FIG. 19 can be repeated until a desired triangle budget for a specific LOD level is achieved. The method can then be further repeated to generate successive LOD levels for further reduced triangle budgets.

FIG. 20 is a flow diagram of method steps for generating a simplified blendshape target corresponding to a first blendshape target in a set of blendshape targets based on morphing a simplified base target mesh, according to one embodiment. In various implementations, the method can be performed by the processor 110, the graphics processor 116, or a combination of the processor 110 and the graphics processor 116. In some embodiments, two or more steps shown in FIG. 20 may be performed by the same process or at the same time or in a different order.

As shown, the method begins at step 2002, where the processor creates a copy mesh of a simplified base target mesh. In some embodiments, a base target mesh could be, for example, a full-resolution base target mesh, such as base target mesh 702 shown in FIG. 7. The base target mesh is a polygonal mesh having a first topology. The base target mesh is also associated with a set of blendshape targets that can be used to deform the base target mesh, such as blendshape targets 704A-704D in FIG. 7. A simplified base target mesh can be generated, for example, using the method of FIG. 19.

At step 2004, the processor selects a vertex in the simplified base target mesh, such as, for example, vertex 1402 in FIG. 14. The selected vertex is then processed.

At step 2006, the processor determines a texture space coordinate of the vertex in the simplified base target mesh. At step 2008, the processor identifies a point on the base target mesh corresponding to the texture space coordinate. As described above, some embodiments exploit the fact that the different LODs of the same mesh reference have the same texture, and so share a consistent UV mapping.

At step 2010, the processor identifies a first set of three vertices of the base target mesh that form a triangle that contains the point on the base target mesh. An example is shown as vertices 1602A, 1602B, and 1602C in FIG. 16.

At step 2012, the processor identifies a second set of three vertices of the first blendshape target that corresponds to the first set of three vertices of the base target mesh. An example is shown as vertices 1604A, 1604B, and 1604C in FIG. 16. As described above, a base mesh and its corresponding blendshape targets have a common topology. As such, the second set of three vertices of the first blendshape target that corresponds to the first set of three vertices of the base target mesh have the same vertex indices.

At step 2014, for each vertex in the first set of three vertices, the processor calculates a translation metric corresponding to a difference in location of the vertex in the first set of three vertices and the corresponding vertex in the second set of three vertices. For example, the calculated translation metrics corresponds to translations between vertex 1604A and vertex 1602A, between vertex 1604B and vertex 1602B, and between vertex 1604C and vertex 1602C.

At step 2016, for each vertex in the first set of three vertices, the processor calculates a rotation metric corresponding to a difference in a surface normal of the vertex in the first set of three vertices and the corresponding vertex in the second set of three vertices. For example, the calculated rotation metrics corresponds to rotations of the surface normals between vertex 1604A and vertex 1602A, between vertex 1604B and vertex 1602B, and between vertex 1604C and vertex 1602C.

At step 2018, the processor aggregates the translation metrics to generate an aggregated translation metric. In one embodiments, aggregating the translation metrics comprises taking a mean of the translation metrics.

At step 2020, the processor aggregates the rotation metrics to generate an aggregated rotation metric. In one embodiments, aggregating the rotation metrics comprises taking a mean of the rotation metrics.

At step 2022, the processor identifies, for the vertex in the simplified base target mesh, a corresponding vertex in the copy mesh of the simplified base target mesh. Since the simplified base target mesh and the copy mesh have identical topologies, identify the corresponding vertex in the copy mesh comprises finding the vertex with the same vertex index.

At step 2024, the processor transforms a position and a rotation of the corresponding vertex in the copy mesh based on the aggregated translation metric and the aggregated rotation metric.

At step 2026, the processor determines whether there are any more vertices of the simplified base target mesh to process. If not, the method terminates. If yes, the method returns to step 2004, described above. Once all of the vertices of the simplified base target mesh, the copy mesh effective comprises a LOD for the first blendshape target with identical topology as the simplified base target mesh (i.e., LOD for the base target mesh).

The method described in FIG. 20 can be repeated for each successive blendshape target in the set of blendshape targets to generate LODs for the different blendshape targets.

### Conclusion

Disclosed herein is a system and method for generating LODs for blendshape assets. The disclosed system and method can automatically generate LODs, and also allows artists to mix hand-authoring with automated steps, in a variety of workflows, so saves artist effort.

A first automated method, referred to as the Generate operator, performs traditional quadric polychord collapse mesh simplification, but on a single mesh with multiple geometries. The Generate operator generates LODs for blendshapes such that corresponding LODs (with identical triangle budgets) for different target geometries have consistent topology. The Generate operator takes all the different geometries into account when deciding which edges to collapse - even when only outputting LODs for the base target.

A second automated method, referred to herein as the Morph operator, performs a different operation more akin to morphing, where the vertex positions and normals of an artist-authored LOD mesh of the base target are transformed to take on the shape of another target. The morphed LODs have topology identical to the authored base target LODs, but geometry matching the destination target. Using a multi-step workflow, artists are able to first hand-author the full-res LOD_0 meshes of the blendshape targets, then author a full set of LODs for just the base target (using a combination of the Generate operator and some hand-tweaking), and then rapidly flesh out the rest of the LOD matrix using the Morph operator. This hybrid workflow allows a very effective combination of hand-authoring and automation. Usefully, it allows the artist to hand-tweak (or even hand-author from scratch) the LODs of the base target, on a single copy of the shared topology, before generating the corresponding LODs for the other targets. Also, in the event that an artist wishes to revisit the LODs later to improve their quality, the artist need only edit the LODs of the base target, and can rely on the Morph operator to quickly re-generate the LODs of the other targets, retaining topological consistency.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A method for generating a simplified mesh, the method comprising:
receiving, by one or more processors, a base target mesh, wherein the base target mesh is a polygonal mesh having a first topology, wherein the base target mesh is associated with a set of blendshape targets to deform the base target mesh, wherein each blendshape target in the set of blendshape targets has the first topology;
determining, by the one or more processors, a set of edge collapse operations of the base target mesh that reduce a number of triangles of the base target mesh;
for each edge collapse operation in the set of edge collapse operations, determining, by the one or more processors, a set of values corresponding to performing the edge collapse operation on the base target mesh and each blendshape target in the set of blendshape targets, wherein each value in the set of values is based on a cost metric and a benefit metric of performing the edge collapse operation on the base target mesh or a respective blendshape target in the set of blendshape targets;
for each set of values corresponding to respective edge collapse operations, aggregating, by the one or more processors, the values in the set of values to determine an aggregate value for performing the edge collapse operation on the base target mesh and each blendshape target in the set of blendshape targets;
selecting, by the one or more processors, a first edge collapse operation from the set of edge collapse operations having an optimal aggregate value; and
performing, by the one or more processors, the first edge collapse operation on the base target mesh to generate a simplified base target mesh.

2. The method according to claim 1, further comprising:
performing the first edge collapse operation on each blendshape target in the set of blendshape targets to generate a set of simplified blendshape targets.

3. The method according to claim 1, wherein each blendshape target in the set of blendshape targets having the first topology comprises each blendshape target in the set of blendshape targets having a same number of vertices and a same number of edges as the base target mesh.

4. The method according to claim 1, wherein each blendshape target in the set of blendshape targets has a different geometry, wherein each different geometry comprises different locations of the vertices in the first topology.

5. The method according to claim 1, wherein, for a given edge collapse operation, aggregating the values in the set of values to determine the aggregate value for performing the given edge collapse operation comprises calculating a mean value of the values in the set of values for performing the given edge collapse operation on the base target mesh and each blendshape target in the set of blendshape targets.

6. The method according to claim 1,
wherein the cost metric of performing a given edge collapse operation on the base target mesh or a given blendshape target in the set of blendshape targets corresponds to a change in geometric fidelity of the base target mesh or the given blendshape target based on performing the given edge collapse operation; and
wherein the benefit metric of performing the given edge collapse operation on the base target mesh or a given blendshape target in the set of blendshape targets corresponds to a reduction in a number of triangles of the base target mesh or the given blendshape target based on performing the given edge collapse operation.

7. The method according to claim 1, further comprising:
generating a simplified blendshape target corresponding to a first blendshape target in the set of blendshape targets based on morphing the simplified base target mesh.

8. The method according to claim 7, wherein generating the simplified blendshape target comprises:
creating a copy mesh of the simplified base target mesh; and
for each vertex in the simplified base target mesh:
determining a texture space coordinate of the vertex in the simplified base target mesh;
identifying a point on the base target mesh corresponding to the texture space coordinate;
identifying a first set of three vertices of the base target mesh that form a triangle that contains the point on the base target mesh;
identifying a second set of three vertices of the first blendshape target that corresponds to the first set of three vertices of the base target mesh;
for each vertex in the first set of three vertices, calculating a translation metric corresponding to a difference in location of the vertex in the first set of three vertices and the corresponding vertex in the second set of three vertices;
for each vertex in the first set of three vertices, calculating a rotation metric corresponding to a difference in a surface normal of the vertex in the first set of three vertices and the corresponding vertex in the second set of three vertices;
aggregating the translation metrics to generate an aggregated translation metric;
aggregating the rotation metrics to generate an aggregated rotation metric;
identifying, for the vertex in the simplified base target mesh, a corresponding vertex in the copy mesh of the simplified base target mesh; and
transforming a position and a rotation of the corresponding vertex in the copy mesh based on the aggregated translation metric and the aggregated rotation metric.

9. A non-transitory computer-readable storage medium storing instructions that, when executed by one or more processors, causes a computing device to generate a simplified mesh, by performing operations comprising:
receiving a base target mesh, wherein the base target mesh is a polygonal mesh having a first topology, wherein the base target mesh is associated with a set of blendshape targets to deform the base target mesh, wherein each blendshape target in the set of blendshape targets has the first topology;
determining a set of edge collapse operations of the base target mesh that reduce a number of triangles of the base target mesh;
for each edge collapse operation in the set of edge collapse operations, determining a set of values corresponding to performing the edge collapse operation on the base target mesh and each blendshape target in the set of blendshape targets, wherein each value in the set of values is based on a cost metric and a benefit metric of performing the edge collapse operation on the base target mesh or a respective blendshape target in the set of blendshape targets;
for each set of values corresponding to respective edge collapse operations, aggregating the values in the set of values to determine an aggregate value for performing the edge collapse operation on the base target mesh and each blendshape target in the set of blendshape targets;
selecting a first edge collapse operation from the set of edge collapse operations having an optimal aggregate value; and
performing the first edge collapse operation on the base target mesh to generate a simplified base target mesh.

10. The computer-readable storage medium according to claim 9, wherein the operations further comprise:
performing the first edge collapse operation on each blendshape target in the set of blendshape targets to generate a set of simplified blendshape targets.

11. The computer-readable storage medium according to claim 9, wherein each blendshape target in the set of blendshape targets having the first topology comprises each blendshape target in the set of blendshape targets having a same number of vertices and a same number of edges as the base target mesh.

12. The computer-readable storage medium according to claim 9, wherein each blendshape target in the set of blendshape targets has a different geometry, wherein each different geometry comprises different locations of the vertices in the first topology.

13. The computer-readable storage medium according to claim 9, wherein, for a given edge collapse operation, aggregating the values in the set of values to determine the aggregate value for performing the given edge collapse operation comprises calculating a mean value of the values in the set of values for performing the given edge collapse operation on the base target mesh and each blendshape target in the set of blendshape targets.

14. The computer-readable storage medium according to claim 9,
wherein the cost metric of performing a given edge collapse operation on the base target mesh or a given blendshape target in the set of blendshape targets corresponds to a change in geometric fidelity of the base target mesh or the given blendshape target based on performing the given edge collapse operation; and
wherein the benefit metric of performing the given edge collapse operation on the base target mesh or a given blendshape target in the set of blendshape targets corresponds to a reduction in a number of triangles of the base target mesh or the given blendshape target based on performing the given edge collapse operation.

15. The computer-readable storage medium according to claim 9, wherein the operations further comprise:
generating a simplified blendshape target corresponding to a first blendshape target in the set of blendshape targets based on morphing the simplified base target mesh.

16. The computer-readable storage medium according to claim 15, wherein generating the simplified blendshape target comprises:
creating a copy mesh of the simplified base target mesh; and
for each vertex in the simplified base target mesh:
determining a texture space coordinate of the vertex in the simplified base target mesh;
identifying a point on the base target mesh corresponding to the texture space coordinate;
identifying a first set of three vertices of the base target mesh that form a triangle that contains the point on the base target mesh;
identifying a second set of three vertices of the first blendshape target that corresponds to the first set of three vertices of the base target mesh;
for each vertex in the first set of three vertices, calculating a translation metric corresponding to a difference in location of the vertex in the first set of three vertices and the corresponding vertex in the second set of three vertices;
for each vertex in the first set of three vertices, calculating a rotation metric corresponding to a difference in a surface normal of the vertex in the first set of three vertices and the corresponding vertex in the second set of three vertices;
aggregating the translation metrics to generate an aggregated translation metric;
aggregating the rotation metrics to generate an aggregated rotation metric;
identifying, for the vertex in the simplified base target mesh, a corresponding vertex in the copy mesh of the simplified base target mesh; and
transforming a position and a rotation of the corresponding vertex in the copy mesh based on the aggregated translation metric and the aggregated rotation metric.

17. A device for generating a simplified mesh, the device comprising:
a memory storing instructions; and
one or more processors configured to the execute the instructions to cause the device to:
receive a base target mesh, wherein the base target mesh is a polygonal mesh having a first topology, wherein the base target mesh is associated with a set of blendshape targets to deform the base target mesh, wherein each blendshape target in the set of blendshape targets has the first topology;
determine a set of edge collapse operations of the base target mesh that reduce a number of triangles of the base target mesh;
for each edge collapse operation in the set of edge collapse operations, determine a set of values corresponding to performing the edge collapse operation on the base target mesh and each blendshape target in the set of blendshape targets, wherein each value in the set of values is based on a cost metric and a benefit metric of performing the edge collapse operation on the base target mesh or a respective blendshape target in the set of blendshape targets;
for each set of values corresponding to respective edge collapse operations, aggregate the values in the set of values to determine an aggregate value for performing the edge collapse operation on the base target mesh and each blendshape target in the set of blendshape targets;
select a first edge collapse operation from the set of edge collapse operations having an optimal aggregate value; and
perform the first edge collapse operation on the base target mesh to generate a simplified base target mesh.

18. The device according to claim 17, wherein the one or more processors are further configured to the execute the instructions to cause the device to:
perform the first edge collapse operation on each blendshape target in the set of blendshape targets to generate a set of simplified blendshape targets.

19. The device according to claim 17, wherein each blendshape target in the set of blendshape targets has a different geometry, wherein each different geometry comprises different locations of the vertices in the first topology.

20. The device according to claim 17, wherein the one or more processors are further configured to the execute the instructions to cause the device to:
generate a simplified blendshape target corresponding to a first blendshape target in the set of blendshape targets based on morphing the simplified base target mesh, wherein generating the simplified blendshape target comprises:
creating a copy mesh of the simplified base target mesh; and
for each vertex in the simplified base target mesh:
determining a texture space coordinate of the vertex in the simplified base target mesh;
identifying a point on the base target mesh corresponding to the texture space coordinate;
identifying a first set of three vertices of the base target mesh that form a triangle that contains the point on the base target mesh;
identifying a second set of three vertices of the first blendshape target that corresponds to the first set of three vertices of the base target mesh;
for each vertex in the first set of three vertices, calculating a translation metric corresponding to a difference in location of the vertex in the first set of three vertices and the corresponding vertex in the second set of three vertices;
for each vertex in the first set of three vertices, calculating a rotation metric corresponding to a difference in a surface normal of the vertex in the first set of three vertices and the corresponding vertex in the second set of three vertices;
aggregating the translation metrics to generate an aggregated translation metric;
aggregating the rotation metrics to generate an aggregated rotation metric;
identifying, for the vertex in the simplified base target mesh, a corresponding vertex in the copy mesh of the simplified base target mesh; and
transforming a position and a rotation of the corresponding vertex in the copy mesh based on the aggregated translation metric and the aggregated rotation metric.
